(19) United States
(12) Patent Application Publication
(10) Pub. No.: US 2016/0225343 A1
(43) Pub. Date: Aug. 4, 2016

(54) SWITCHABLE PRIVACY MODE DISPLAY

(71) Applicant: SONY CORPORATION, TOKYO (JP)

(72) Inventors: Martin Ek, Lund (SE); Alexander Hunt, Tygelsjo (SE)

(21) Appl. No.: 14/613,980

(22) Filed: Feb. 4, 2015

(51) Int. Cl. G09G 5/02; G06T 1/20

(52) U.S. Cl. CPC G09G 5/026; G06T 1/20; G09G 2358/00

(57) ABSTRACT

A device includes a color display that includes a plurality of pixels, wherein a particular pixel of the plurality of pixels includes a first set of subpixels configured to emit a first set of colors; and a second set of subpixels configured to emit a second set of colors, wherein the second set of colors is offset from the first set of colors by a wavelength range. The device may further include logic configured to obtain an image; detect activation of a privacy mode; generate an inverse image of the obtained image; display the obtained image using the first set of subpixels; and display the generated inverse image using the second set of subpixels, in response to detecting the activation of the privacy mode.

### BACKGROUND INFORMATION

Electronic devices, such as mobile communication devices, may include a screen that displays information to a user. The user may use the electronic device to view private information, such as private financial information or a confidential email. Often, the user may be in public, such as when the user is sitting in a waiting room, standing in line, or riding on public transportation. In such public situations, other people may easily view the screen of the user's device, especially if the user device includes a display viewable from a wide variety of angles. Thus, being in public may limit the user's ability to comfortably view private information on a display of the user's device.

### SUMMARY OF THE INVENTION

According to one aspect, a device may include a color display that includes a plurality of pixels, wherein a particular pixel of the plurality of pixels includes a first set of subpixels configured to emit a first set of colors; and a second set of subpixels configured to emit a second set of colors, wherein the second set of colors is offset from the first set of colors by a wavelength range. The device further includes logic configured to obtain an image; detect activation of a privacy mode; generate an inverse image of the obtained image; display the obtained image using the first set of subpixels; and display the generated color inverse image using the second set of subpixels, in response to detecting the activation of the privacy mode.

According to another aspect, a method, performed by a computing device, may include obtaining, by the computing device, an image; detecting, by the computing device, activation of a privacy mode; generating, by the computing device, an inverse image of the obtained image; displaying, by the computing device, the obtained image using a first set of subpixels, wherein the first set of subpixels configured to emit a first set of colors; and displaying, by the computing device, the generated inverse image using a second set of subpixels, in response to detecting the activation of the privacy mode, wherein the second set of subpixels configured to emit a second set of colors, and wherein the second set of colors is offset from the first set of colors by a wavelength range.

According to yet another aspect, a system may include a mobile communication device comprising a color display that includes a plurality of pixels, wherein a particular pixel of the plurality of pixels includes a first set of subpixels configured to emit a first set of colors; and a second set of subpixels configured to emit a second set of colors, wherein the second set of colors is offset from the first set of colors by a wavelength range. The system may further include a pair of eyeglasses comprising a plurality of color filters configured to filter out the second set of colors.

### BRIEF DESCRIPTION OF THE DRAWINGS

FIG. 1 is a diagram illustrating an overview of a selectable privacy mode according to an implementation described herein;

FIG. 2 is a diagram illustrating an exemplary system according to an implementation described herein;

FIG. 3 is a diagram illustrating exemplary components of the user device of FIG. 2;

FIG. 4 is a diagram illustrating exemplary components of the touchscreen of FIG. 2;

FIG. 5 is a diagram illustrating a first exemplary implementation of a privacy model display according to an implementation described herein;

FIG. 6 is a diagram illustrating a second exemplary implementation of a privacy model display according to an implementation described herein;

FIG. 7 is a diagram illustrating exemplary functional components of the user interface of FIG. 3;

FIG. 8 is a flow chart of an exemplary process for generating a privacy mode display according to an implementation described herein; and

FIG. 9 is a flow chart of an exemplary process for implementing a privacy mode display according to an implementation described herein.

### DETAILED DESCRIPTION OF PREFERRED EMBODIMENTS

The following detailed description refers to the accompanying drawings. The same reference numbers in different drawings identify the same or similar elements.

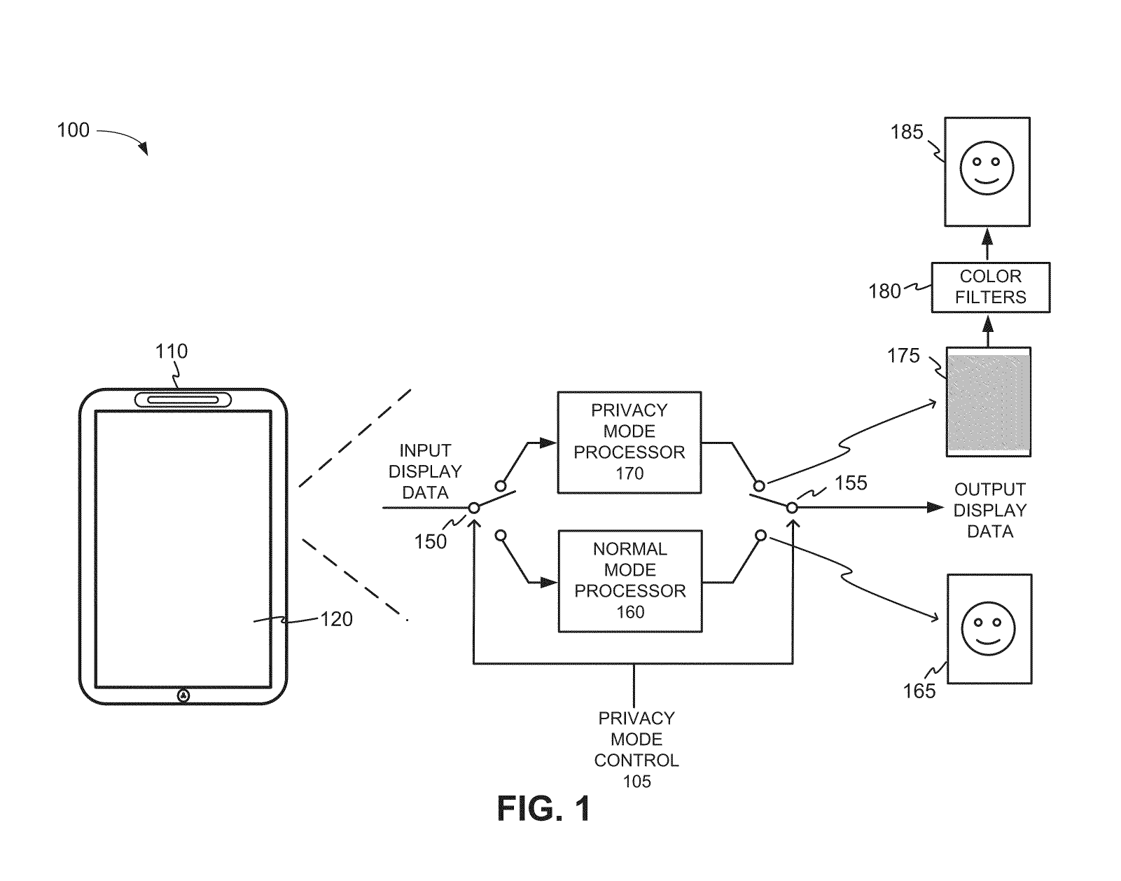

Implementations described herein relate to a switchable privacy mode display. FIG. 1 is a diagram illustrating an overview of a switchable privacy mode. As shown in FIG. 1, overview 100 includes a user device 110. User device 110 may include a privacy mode control 105 and a display 120. Input display data 150 is processed by privacy mode control 105 to generate output display data 155. Privacy mode control 105 may be used to select a privacy mode for display 120 and may be activated by the user and/or may be activated based on one or more trigger events. Input display data 150 may be sent to either a normal mode processor 160 or to a privacy mode processor 170. If a privacy mode is selected by privacy mode control 105. If normal mode is selected and input display data 150 is processed by normal mode processor 160, output display data 155 corresponds to normal output data 165, which may result in the display data being visible on display 120. If privacy mode is selected and input display data 150 is processed by privacy mode processor 170, output display data 155 corresponds to obscured output data 175, which may appear as a neutral gray screen. When the gray screen is viewed through one or more color filters 180, for example mounted on a pair of glasses, output data 185 may become visible as color filters 180 filter out a portion of the obscured output data, as described in detail below.

Privacy mode processor 170 may generate obscured output data 175 by generating an inverse image of input display data 150. An inverse image includes pixels that have complementary colors to the colors of the corresponding pixels in input display data 150. Mixing a color and its complementary color in equal amounts results in a neutral gray color. For example, in Red Green Blue (R,G,B) hexadecimal notation, the complementary color of (x, y, z) is given by (FF-x, FF-y, FF-z), where FF represents the maximum color intensity value, in hexadecimal notation, for the color scheme used by display 120. Thus, when an image and the inverse of the image are displayed at the same time, the resulting output image may be a neutral gray image. An “image,” as the term is used herein, may refer to any data that is to be displayed on the screen of display 120, and may include text, icons, images, video, and/or other type of visual data. When privacy mode processor 170 processes input display data, additional image processing may be performed (e.g., reformatting, filtering, color correction, brightness correction, gamma correction, etc.) to produce output display data 155, which may display the information represented in the input display data 150 on display 120. For example, privacy mode processor 170 may perform gamma correction to achieve a gray average for the output image in privacy mode.

In a color display, a pixel includes a set of subpixels that combine to generate a particular color. For example, in an RGB color model, a pixel may include a red subpixel, a green subpixel, and a blue subpixel. The resulting color of the pixel may depend on the relative intensities of the subpixels. Implementations described herein relate to a display device that includes at least two sets of subpixels for each pixel. Thus, a pixel of display device 120 may include a first set of subpixels that includes a red subpixel, a green subpixel, and a blue subpixel; and a second set of subpixels that includes an offset red subpixel, an offset green subpixel, and an offset blue subpixel. The offset subpixels may emit light at offset frequencies in relation to the first set of subpixels. As an illustrative example, if the peak emission wavelength of the blue subpixel is at 450 nanometers (nm), the peak emission wavelength of the offset blue subpixel may be at 475 nm; if the peak emission wavelength of the green subpixel is at 525 nm, the peak emission wavelength of the offset green subpixel may be at 575 nm; and if the peak emission wavelength of the red subpixel is at 625 nm, the peak emission wavelength of the offset red subpixel may be at 675 nm. Thus, the offset subpixels may be close enough in emission wavelength to the non-offset subpixels to emit complementary colors when displaying an inverse image with respect to the image displayed by the non-offset subpixels, and yet far enough in emission wavelength to be filtered out with a set of notch filters included in color filters 180.

When privacy mode is activated, the normal image may be displayed using the first set of subpixels and the inverse image may be displayed using the second set of subpixels. The light from the two sets of subpixels may combine to generate a neutral gray image when viewed by anyone looking at the screen of display 120, since the human eye will average out the colors and the complementary colors displayed by adjacent pixels into a neutral gray color. Thus, anyone looking at the screen of display 120 will only see a neutral gray image and will not be able to view the displayed information. However, if color filters 180 filter out the wavelengths of the second set of subpixels, then the normal image may become visible. In other words, color filters 180 may be transparent to light emitted by the first set of subpixels and may block the light emitted by the second set of subpixels. Thus, if a user views the generated neutral gray image with a set of glasses that includes color filters 180, the user may be able to view the output data 185. Furthermore, the user may be able to view output data 185 from a wide variety of angles while wearing the set of glasses.

The privacy mode may be activated explicitly by the user or may be activated in response to a privacy mode trigger event. The privacy mode trigger event may include a privacy tag associated with a data item, a type of data associated with the data item, a data source associated with the data item, a location of user device 120, a particular access point device associated with user device 120, a time of day and/or day of week, whether the user is wearing the privacy mode eyeglasses, and/or another type of privacy mode trigger event. Furthermore, the privacy mode may be applied to the whole screen of display 120 or to only a portion of the screen.

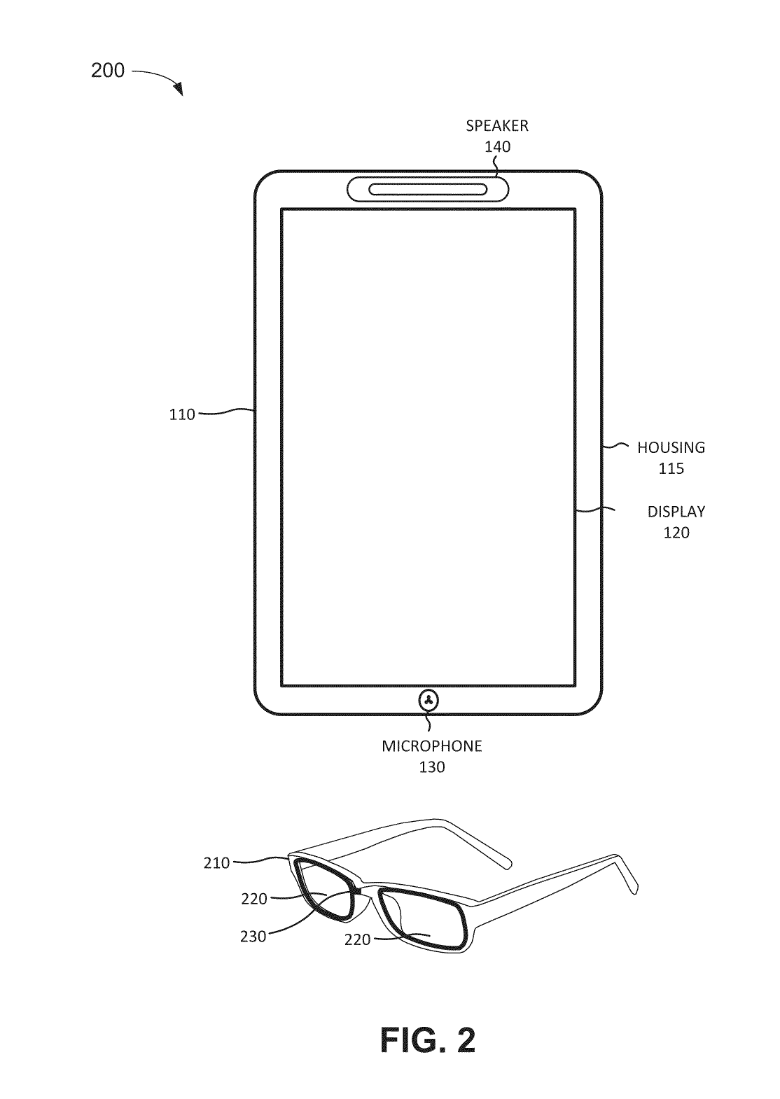

FIG. 2 is a diagram illustrating an exemplary system 200 according to an implementation described herein. As shown in FIG. 2, system 200 may include user device 110 and a color filters device 210. User device 110 may include a mobile communication device, such as a smart phone. While FIG. 2 depicts user device 110 as a smart phone, in other implementations, user device 110 may include a different type of a portable communication device (e.g., a mobile phone, a phablet device, a wearable computer device (e.g., a glasses smartphone device, a wristwatch smartphone device, etc.), global positioning system (GPS) device, and/or another type of wireless device); a laptop, tablet, or another type of portable computer; a media playing device; a portable gaming system; and/or any other type of portable computer device with a screen that displays visual data. Furthermore, in other implementations, user device 110 may include another type of device, such as a desktop computer, a server device, a television, an automated teller machine (ATM), a point-of-sale terminal, and/or another type of device configured to display private information to a user. As shown in FIG. 2, user device 110 may include a housing 115, display 120, a microphone 130, and a speaker 140.

Housing 115 may enclose user device 110 and may protect the components of user device 110 from the outside elements (e.g., moisture, dirt, etc.). Display 120 may include a display device configured to output a display via an array of pixel elements. Display 120 may include a touchscreen that includes a display and an input device configured to detect a user's touch. The touchscreen may be used to detect a particular gesture to activate and/or de-activate the privacy mode. Display 120 may be a wide angle display in which images are viewable from a wide variety of angles. While FIG. 2 illustrates user device 110 with a touchscreen, in other implementations, user device 110 may not necessarily include a touchscreen. For example, user device 110 may include a display and a keyboard and/or keypad. Display 120 may include a liquid crystal display (LCD), an electroluminescent display, and/or another type of display. Furthermore, display 120 may include touch sensors, such as capacitive sensors (e.g., surface capacitive sensors, projected capacitive touch sensors, etc.), resistive sensors (e.g., analog resistive sensors, digital resistive sensors, etc.), optical sensors (e.g., optical imaging sensors, rear diffused illumination sensors, infrared grid sensors, diffused surface illumination sensors, etc.), acoustic wave sensors (e.g., surface acoustic wave sensors, bending wave sensors, etc.), and/or another type of touch sensors. Furthermore, display 120 may include sensors to sense an amount of force being applied to display 120, such as piezoresistive sensors.

Microphone 130 may receive audio signals and convert the received audio signals to electrical signals for user device 110. Microphone 130 may be used to detect a spoken command to activate the privacy mode. Speaker 140 may receive electrical signals from within user device 110 and generate audio signals based on the received electrical signals. Speaker 140 may be used to generate an audio message to inform the user when privacy mode is activated or de-activated.

User device 110 may include additional sensors (not shown in FIG. 2). For example, user device 110 may include one or more tilt sensors, such as accelerometers and/or gyroscopes, configured to sense a tilt, position, and/or orientation of user device 110 in space; one or more Global Positioning System (GPS) receivers; one or more magnetic field sensors (e.g., to sense the magnetic North); motion detection sensors to sense motion in the vicinity of user device 110; and/or other types of sensors. The GPS receiver may be used to determine the location of user device 110. Particular locations may trigger user device 110 to automatically enter the privacy mode. Tilt sensors and/or motion sensors may be used to activate the privacy mode based on the user performing a particular movement with user device 110.

Color filters device 210 may include a device that includes a set of color filters. For example, color filters device 210 may include a pair of eyeglasses. Color filters device 210 may include a set of color filters 220 and a trigger pattern 230. Color filters 220 may correspond to color filters 180 described above with reference to overview 100 of FIG. 1. Color filters 220 may be used to filter out a set of colors generated by display 120 when the privacy mode is activated, so that a user can view images being displayed in the privacy mode. Thus, if display 120 includes a first set of subpixels with a red subpixel, a green subpixel, and a blue subpixel, and a second set of subpixels with an offset red subpixel, an offset green subpixel, and an offset blue subpixel, color filters 220 may filter out a first wavelength range generated by the offset red subpixel with a first notch filter, may filter out a second wavelength range generated by the offset green subpixel with a second notch filter, and may filter out a third wavelength range generated by the offset blue subpixel with a third notch filter.

Color filters device 210 may include any type of viewing device permitting a wearer to properly interpret the contents of display 120 when user device 110 is in the privacy display mode. Color filters device 210 may include any type of optical device configured to block particular wavelength ranges associated with the light emitted by display 120 while in privacy mode. Color filters device 210 may include color filter components for both eyes, such as eyeglasses or clip-on accessories which may be removably attached to prescription glasses. However, in some embodiments, the eyeglasses may only cover one eye with a color filters component (e.g., a monocle). Other embodiments may include headsets, one or more contact lens, or eyeglasses forgoing the use of temples which are supported by a user's hand instead of being worn, either using a handle (similar to opera glasses) or a portion of the frame.

In some implementations, the notch filters may include optical coatings. For example, the notch filters may include a first optical coating that absorbs, refracts, and/or reflects the first wavelength range, a second optical coating that absorbs, refracts, and/or reflects the second wavelength range, and a third optical coating that absorbs, refracts, and/or reflects the third wavelength range. In other implementations, the notch filters may be implemented using another technique. For example, the notch filters may be implemented using planar waveguide structures deposited and/or formed onto the lenses of the eyeglasses. The planar waveguide structures may be made from silica glass or from another type of glass material.

Trigger pattern 230 may include a pattern that may be recognized by a front camera (not shown in FIG. 2) of user device 110. The pattern may include a matrix barcode or another type of pattern that is recognized by user device 110. When the user puts on color filters device 210 and looks at user device 110, user device 110 may recognize the pattern and may, in response, automatically trigger user device 110 to enter the privacy mode.

Although FIG. 2 show exemplary components of user device 110 and color filters device 210, in other implementations, user device 110 and/or color filters device 210 may include fewer components, different components, differently arranged components, or additional components than those depicted in FIG. 2.

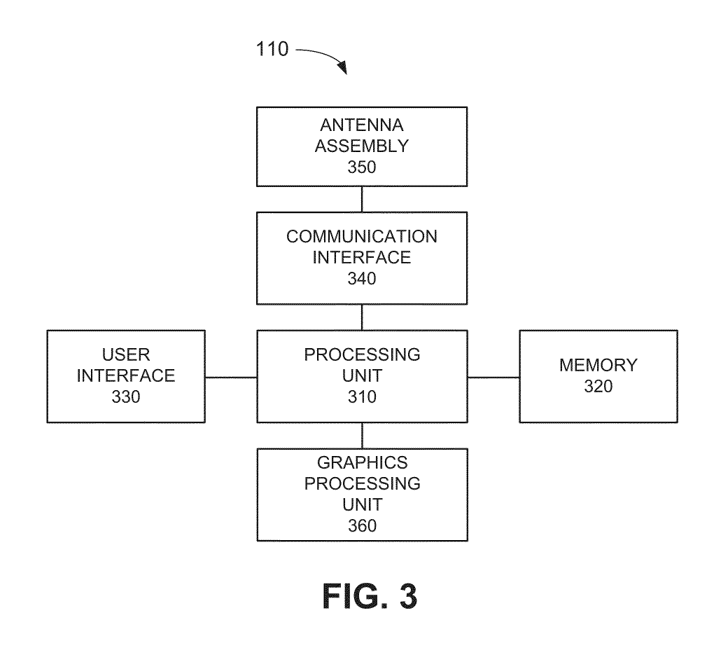

FIG. 3 is a diagram illustrating exemplary components of user device 110 according to an implementation described herein. As shown in FIG. 3, user device 110 may include a processing unit 310, a memory 320, a user interface 330, a communication interface 340, an antenna assembly 350, and a graphics processing unit (GPU) 360.

Processing unit 310 may include one or more processors, microprocessors, application specific integrated circuits (ASICs), field programmable gate arrays (FPGAs), and/or other processing logic. Processing unit 310 may control operation of user device 110 and its components.

Memory 320 may include a random access memory (RAM) or another type of dynamic storage device, a read only memory (ROM) or another type of static storage device, a removable memory card, and/or another type of memory to store data and instructions that may be used by processing unit 310.

User interface 330 may allow a user to input information to user device 110 and/or to output information from user device 110. Examples of user interface 330 may include logic configured to control display 120, logic configured to control and/or obtain information from microphone 130, logic configured to control speaker 140; logic configured to receive and output information from communication interface 340; logic configured to control and/or obtain information from buttons (e.g., a joystick, control buttons, a keyboard, or keys of a keypad) and/or a touchscreen; logic configured to control an actuator to cause user device 110 to vibrate; a sensor; and/or logic associated with any other type of input or output device.

Communication interface 340 may include a transceiver that enables user device 110 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 340 may include a transmitter that converts baseband signals to radio frequency (RF) signals and/or a receiver that converts RF signals to baseband signals. Communication interface 340 may be coupled to antenna assembly 350 for transmitting and receiving RF signals.

Communication interface 340 may include a logical component that includes input and/or output ports, input and/or output systems, and/or other input and output components that facilitate the transmission of data to other devices. For example, communication interface 340 may include a network interface card (e.g., Ethernet card) for wired communications and/or a wireless network interface (e.g., a WiFi) card for wireless communications. Communication interface 340 may also include a universal serial bus (USB) port for communications over a cable, a Bluetooth™ wireless interface, a radio-frequency identification (RFID) interface, a near-field communications (NFC) wireless interface, and/or any other type of interface that converts data from one form to another form.

Antenna assembly 350 may include one or more antennas to transmit and/or receive RF signals. Antenna assembly 350 may, for example, receive RF signals from communication interface 340 and transmit the signals via an antenna and receive RF signals from an antenna and provide them to communication interface 340.

GPU 360 may include one or more devices that include specialized circuits for performing operations relating to graphics processing (e.g., block image transfer operations, simultaneous per-pixel operations, etc.) and/or for performing a large number of operations in parallel. GPU 360 may be used by processing unit 310 to speed up image processing according to one or more implementations described herein.

As described herein, user device 110 may perform certain operations in response to processing unit 310 executing software instructions contained in a computer-readable medium, such as memory 320. A computer-readable medium may be defined as a non-transitory memory device. A non-transitory memory device may include memory space within a single physical memory device or spread across multiple physical memory devices. The software instructions may be read into memory 320 from another computer-readable medium or from another device via communication interface 340. The software instructions contained in memory 320 may cause processing unit 310 to perform processes that will be described later. Alternatively, hardwired circuitry may be used in place of, or in combination with, software instructions to implement processes described herein. Thus, implementations described herein are not limited to any specific combination of hardware circuitry and software.

Although FIG. 3 shows exemplary components of user device 110, in other implementations, user device 110 may include fewer components, different components, differently arranged components, or additional components than those depicted in FIG. 3. Additionally or alternatively, one or more components of user device 110 may perform the tasks described as being performed by one or more other components of user device 110.

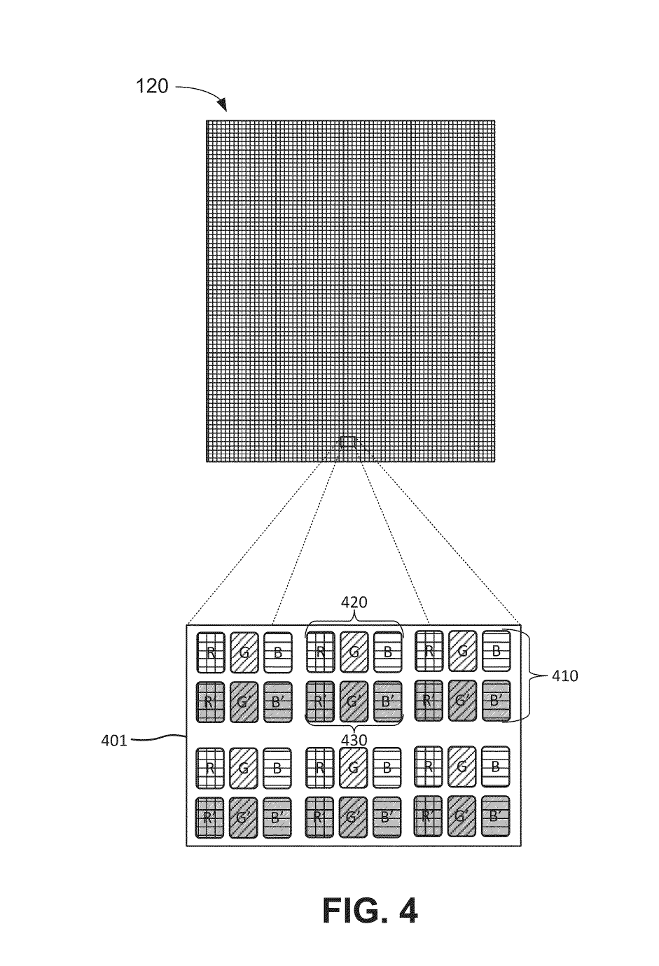

FIG. 4 is a diagram illustrating exemplary components of display 120. As shown in close-up 401 of FIG. 4, display 120 may include an array of pixels 410. Each pixel 410 may include a first set of subpixels 420 and a second set of subpixels 430.

First set of subpixels 420 may include a red subpixel, a green subpixel, and a blue subpixel, labeled R, G, B in FIG. 4. The red subpixel may emit electromagnetic radiation in the visible spectrum (referred to herein as “light”) in the red range of the visible light spectrum. The green subpixel may emit light in the green range of the visible light spectrum. The blue subpixel may emit light in the blue range of the visible light spectrum.

Second set of subpixels 430 may include an offset red subpixel, an offset green subpixel, and an offset blue subpixel, labeled as R′, G′, and B′ in FIG. 4. The offset red subpixel may emit light in a wavelength range that is offset from the red range of the red subpixel by a first wavelength range. The offset green subpixel may emit light in a wavelength range that is offset from the green range of the green subpixel by a second wavelength range. The offset blue subpixel may emit light in a wavelength range that is offset from the blue range of the blue subpixel by a third wavelength range.

In some implementations, first set of subpixels 420 and second set of subpixels 430 may include color filters with a light source located behind the color filters. Any type of light source that generates a white back light may be used. As an example, pixels 410 may illuminated from behind or from the edges by white LEDs. As another example, pixels 410 may be illuminated from behind by organic LEDs (OLEDs).The LEDs may be located along one or more edges of display 120 and/or may be distributed behind pixels 410 (e.g., one LED per pixel, one LED per a group of pixels, etc.). The illumination intensity of each subpixel may be controlled by a liquid crystal layer.

In other implementations, first set of subpixels 420 and second set of subpixels 430 may directly emit light. As an example, display 120 may include a field sequential display and first set of subpixels 420 may include a red LED, a green LED, and a blue LED, and second set of subpixels 430 may include an offset red LED, an offset green LED, and an offset blue LED. In a field sequential display, the red LEDs may be lit during a first part of the cycle, the green LEDs may be lit during a second part of the cycle, and the blue LEDs may be lit during a third part of the cycle. When the privacy mode is activated, the offset red LED may be lit during a fourth part of the cycle, the offset green LED may be lit during a fifth part of the cycle, and the offset blue LED may be lit during a sixth part of the cycle. Alternatively, when privacy mode is activated, the red LED may be lit during a first part of the cycle, the offset red LED may be lit during a second part of the cycle, the green LED may be lit during a third part of the cycle, the offset green LED may be lit during a fourth part of the cycle, the blue LED may be lit during a fifth part of the cycle, and the offset blue LED may be lit during a sixth part of the cycle. However, any cycle may be used and some color LEDs may be activated more frequently and/or for a different length of time than LEDs of another color. For example, the green LED and/or the offset green LED may be lit more frequently than the blue LED and/or the offset blue LED. Such unequal cycles may be used, for example, to reduce color break-up.

As another example, first set of subpixels 420 and second set of subpixels 430 may include phosphors that emit light when activated. As an example, first set of subpixels 420 may include a red phosphor, a green phosphor, and a blue phosphor, and second set of subpixels 430 may include an offset red phosphor, an offset green phosphor, and an offset blue phosphor. For example, display 120 may include a field emission display, a laser phosphor display, a thick-film dielectric electroluminescent display, and/or another type of phosphor display.

Although FIG. 4 shows an exemplary arrangement of subpixels 420 and 430, in other implementations, subpixels 420 and/or 430 may include a different arrangement. For example, subpixels 420 and/or 430 may be in a triangular arrangement, in a diagonal arrangement, in a cross-shaped arrangement, and/or in another type of arrangement. In a triangular arrangement, the red, green, and blue subpixels may form a first triangle and the offset red, offset green, and offset blue subpixels may form a second triangle that is adjacent to, and inverted with respect to, the first triangle. In a diagonal arrangement, the subpixels may be aligned in diagonal lines with respect to the sides of display 120. Furthermore, while subpixels 420 and/or 430 are shown as having a rectangular shape, in other implementations, subpixels 420 and/or 430 may have a different shape, such as a square shape, a circular shape, an elliptical shape, a triangular shape, and/or another type of shape.

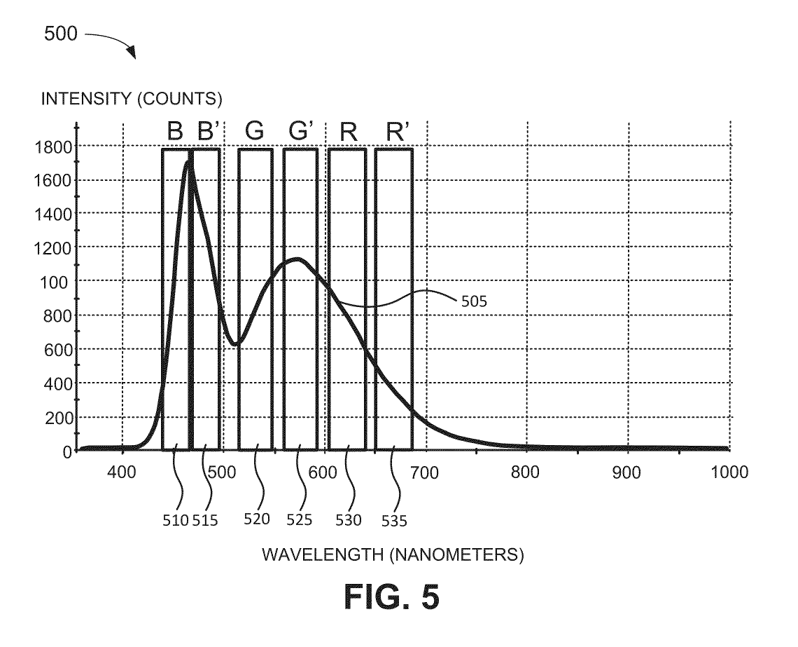

FIG. 5 is a diagram illustrating a first exemplary implementation of a privacy model display according to an implementation described herein. FIG. 5 shows a graph 500 of intensity versus wavelength in an implementation where first set of subpixels 420 (R, G, B in FIG. 4) and second set of subpixels 430 (R′, G′, B′ in FIG. 4) include color filters. Curve 505 illustrates the light emission of a white LED. White LEDs may exhibit a high intensity emission in the blue wavelengths because white LEDs may be manufactured as low-cost blue LEDs covered with a white phosphor. While the LED emits white light after the blue light strikes the white phosphor coating, some of the generated blue light from the blue LED penetrates through. The light from the white LED then strikes the color filters of first set of subpixels 420 and second set of subpixels 430.

As shown in FIG. 5, in an exemplary implementation, a blue color filter may filter light to a first wavelength range 510 from about 430 nanometers (nm) to about 470 nm; an offset blue color filter may filter light to a second wavelength range 515 from about 470 nm to about 500 nm; a green color filter may filter light to a third wavelength range 520 from about 520 nm to about 550 nm; an offset green color filter may filter light to a fourth wavelength range 525 from about 550 nm to about 580 nm; a red color filter may filter light to a fifth wavelength range 530 from about 610 nm to about 640 nm; and an offset red color filter may filter light to a sixth wavelength range 535 from about 650 nm to about 680 nm.

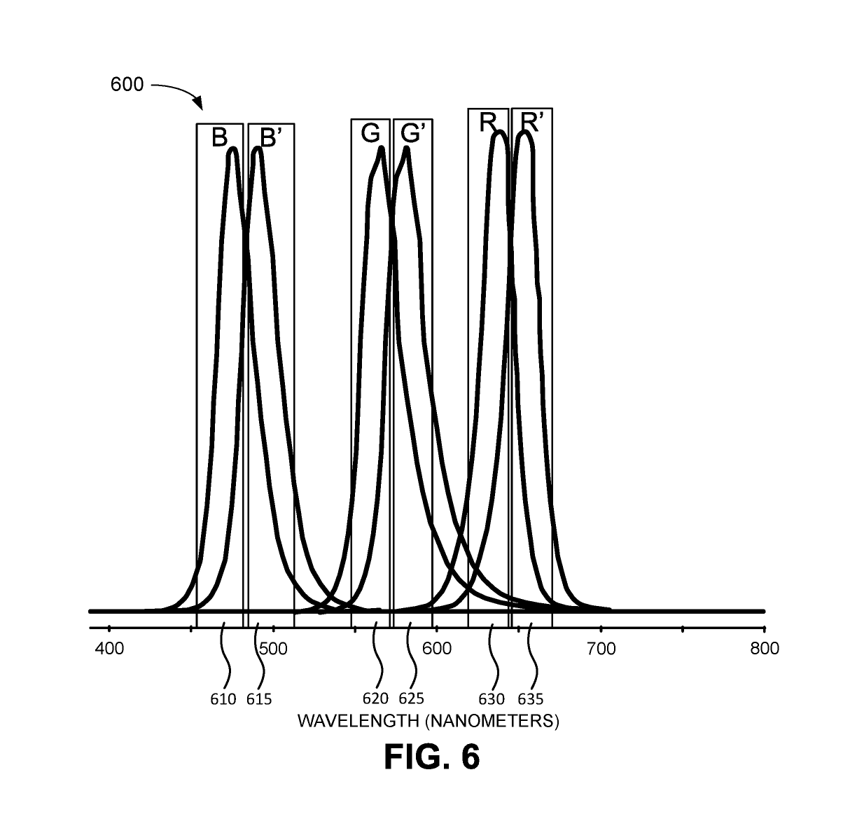

FIG. 6 is a diagram illustrating a second exemplary implementation of a privacy model display according to an implementation described herein. FIG. 6 shows a graph 600 of intensity versus wavelength in an implementation where first set of subpixels 420 and second set of subpixels 430 include color LEDs. As shown in FIG. 6, in an exemplary implementation, a blue LED may emit light in a first wavelength range 610 with a peak at about 475 nm; an offset blue LED may emit light in a second wavelength range 615 with a peak at about 490 nm; a green LED may emit light in a third wavelength range 620 with a peak at about 575 nm; a green offset LED may emit light in a fourth wavelength range 625 with a peak at about 590 nm; a red LED may emit light in a fifth wavelength range 630 with a peak at about 640 nm; and an offset red LED may emit light in a sixth wavelength range 635 with a peak at about 660 nm.

While FIGS. 5 and 6 show particular wavelength ranges associated with particular subpixels, in other implementations the wavelengths ranges may differ. For example, the wavelength ranges may be wider, narrower, centered on a different peak wavelength, and/or separated from each other by different wavelength ranges.

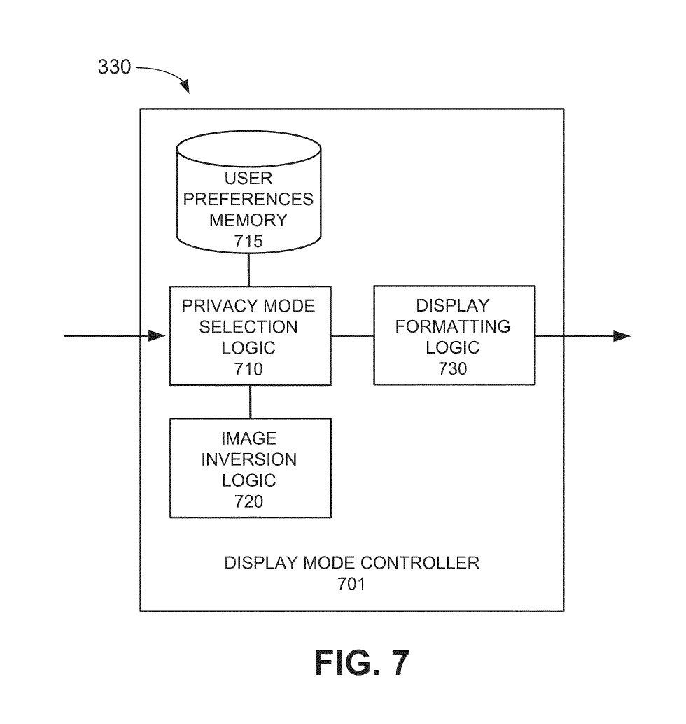

FIG. 7 is a diagram illustrating exemplary functional components of user interface 330. The functional components of user interface 330 may be implemented, for example, via processing unit 310 executing instructions from memory 320. Alternatively, some or all of the functional components of user interface 330 may be implemented via hard-wired circuitry. As shown in FIG. 7, user interface 330 may include a display mode controller 701. Display mode controller 701 may correspond to privacy mode control 105 described above with reference to overview 100 of FIG. 1, and may select either normal view mode or privacy view mode for display 120. Display mode controller 701 may include a privacy mode selection logic 710, a user preferences memory 715, an image inversion logic 720, and a display formatting logic 730.

Privacy mode selection logic 710 may determine when privacy mode is to be activated and may select privacy mode in response. The privacy mode may be activated based on a user selection of the privacy mode and/or based on a privacy mode trigger event. The privacy mode trigger event may be based on the type of data that is to be displayed, based on a privacy tag associated with a data item, based on a location of user device 110 (e.g., home vs. away from home), based on an access point device associated with user device 110 (e.g., home WiFi access point vs. a public WiFi access point), based on whether the user is wearing color filters device 210, and/or based on another type of privacy mode trigger.

User preferences memory 715 may store user preferences associated with privacy mode selection. For example, user preferences memory 715 may store particular privacy mode trigger events selected by the user, particular areas of display 120 designated for privacy mode during particular events (e.g., a particular application being open, a particular web site being visited, etc.), particular locations where the privacy mode should be activated, particular times of day when the privacy mode should be activated, and/or other types of user preferences relating to the privacy mode.

Image inversion logic 720 may generate an inverse image based on an image that is to be displayed in privacy mode. For example, image inversion logic 720 may generate pixels with color values of (MAX-x, MAX-y, MAX-z) for pixels with color values of (x, y, z), where MAX is the maximum color value (e.g., FF in hexadecimal notation) a subpixel may have in the color scheme used by display 120. Image inversion logic 720 may use graphics processing unit 360 to generate the inverse image. If privacy mode is to be applied to only a particular area of display 120, image inversion logic 720 may need to generate an inverse image for only the particular area. Image inversion logic 720 may perform other image processing on the inverse image to improve performance. For example, image inversion logic 720 may perform reformatting, filtering, color correction, brightness correction, gamma correction, and/or other image processing operations on the inverse image to achieve a gray average when the image and the inverse image are displayed together.

Display formatting logic 730 may format the images for display on display 120. For example, when user device 110 is in normal view mode (e.g., not in privacy mode), display formatting logic 730 may not need to perform any processing and may output the image to display 120. If privacy mode is activated, display formatting logic 730 may format the image so that the first set of subpixels 420 display the image while the second set of subpixels 430 display the generated inverse image. In other implementations, display formatting logic 730 may format the image so that the second set of subpixels 430 display the image while the first set of subpixels 420 display the generated inverse image. If display 120 includes a field sequential display, display formatting logic 730 may generate a particular display cycle, such that a first part of the cycle activates first set of subpixels 420 in sequence and the second part of the cycle activates the second set of subpixels 430 in sequence. Alternatively, the cycle may follow a different pattern, such as red LED, followed by the offset red LED, green LED, followed by the offset green LED, blue LED, followed by the offset blue LED. A particular cycle may be selected to minimize flickering and/or to minimize color break up. Furthermore, in some implementations, in order to minimize flickering and/or color break up, the frame refresh rate of display 120 may be doubled during privacy mode.

Although FIG. 7 shows exemplary functional components of user interface 330, in other implementations, user interface 330 may include fewer functional components, different functional components, differently arranged functional components, or additional functional components than those depicted in FIG. 7. Additionally or alternatively, one or more functional components of user interface 330 may perform functions described as being performed by one or more other functional components of user interface 330.

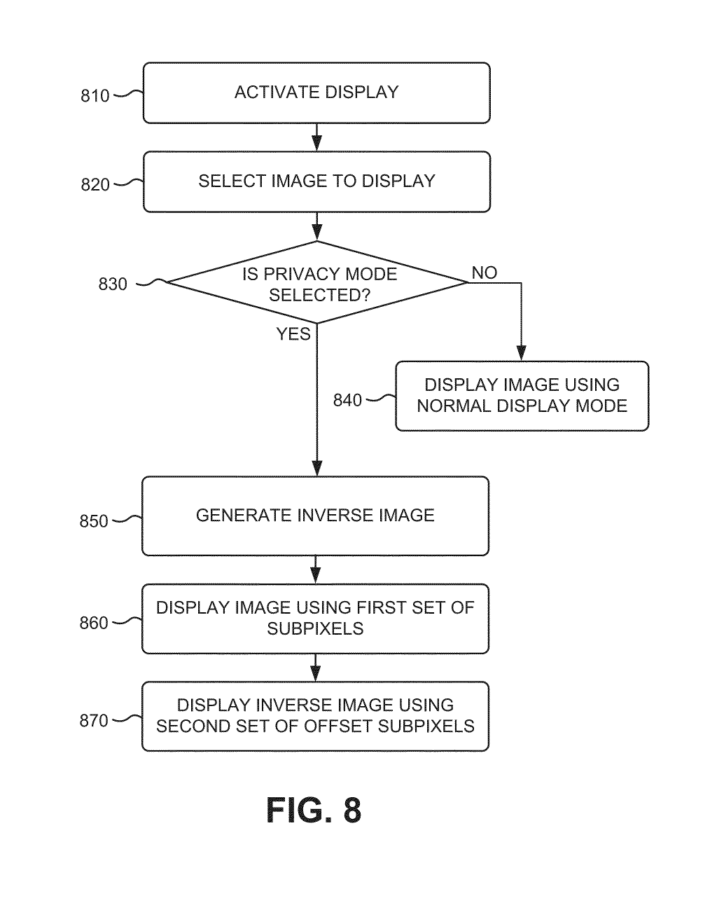

FIG. 8 is a flow chart of an exemplary process for generating a privacy mode display according to an implementation described herein. In some implementations, the process of FIG. 8 may be performed by user device 110. In other implementations, some or all of the process of FIG. 8 may be performed by another device or a group of devices separate from user device 110 or including user device 110, such as a server device via which information sent to user device is transmitted.

The process of FIG. 8 may include activating a display (block 810). As an example, the user may turn on display 120. As another example, display 120 may receive an incoming message and/or may generate a notification and may activate display 120 in response. An image to display may be selected (block 820). The image may include, for example, an image of icons on a start screen of user device, an incoming message and/or notification (which may include text, icon, images, etc.), a screen generated by an application on user device 110, a web page, a video stream generated by a media player, and/or another type of image or set of images.

A determination may be made as to whether privacy mode is selected (block 830). For example, display mode controller 701 may determine whether the user has selected the privacy mode or a privacy mode may be detected. If privacy mode is not selected (block 830—NO), the image may be displayed using normal display mode (block 840). In some implementation, during normal mode, when the privacy mode is not activated, display mode controller 701 may display the image using only first set of subpixels 420. In other implementations, the image may be displayed using both sets of subpixels while in normal mode. In other words, both first set of subpixels 420 and second set of subpixels 430 may display the same data (as opposed to the second set of subpixels 430 displaying the inverse image in privacy mode).

If privacy mode is selected (block 830—YES), an inverse image may be generated (block 850). For example, image inversion logic 720 may generate an inverse image for the image selected for display. The image may be displayed using a first set of subpixels (block 860) and the inverse image may be displayed using a second set of subpixels (block 870). For example, in implementation where subpixels 420 and 430 include color filters, display formatting logic 730 may cause first set of subpixels 420 to display the selected image and may cause second set of subpixels 430 to display the generated inverse image. In implementations where display 120 includes a field sequential display, display formatting logic 730 may cause first set of subpixels 420 to display the selected image during a first part of the display cycle and may cause second set of subpixels 430 to display the generated inverse image during a second part of the display cycle. The displayed image and the display inverse image may blend to generate a neutral gray image. If a user wears color filters device 210, the user may filter out the inverse image to view the displayed image.

The use may select to de-activate the privacy mode and return to the normal view mode by pressing a button, tracing out a particular pattern on display 120, speaking a command, taking off color filters device 210, and/or perform another type of action that user device 110 is configured to recognize as de-activation of the privacy mode. Furthermore, in some implementations, before the privacy mode is activated, the information to be obscured may be displayed for a brief period (e.g, 1-2 seconds), enabling the user to get a quick glimpse of the information before having to put on color filters device 210.

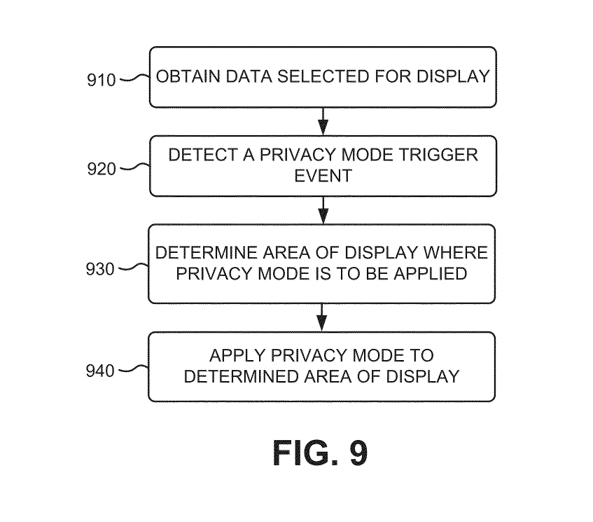

FIG. 9 is a flow chart of an exemplary process for implementing a privacy mode display according to an implementation described herein. In some implementations, the process of FIG. 9 may be performed by user device 110. In other implementations, some or all of the process of FIG. 9 may be performed by another device or a group of devices separate from user device 110 or including user device 110, such as a server device (e.g., a secure server, a company server, etc.) that sends data to user device 110.

The process of FIG. 9 may include obtaining data selected for display (block 910). As an example, the user may turn on display 120. As another example, display 120 may receive an incoming message and/or may generate a notification and may activate in response. A privacy mode trigger event may be detected (block 920). As an example, a user may select privacy mode by selecting a privacy mode icon on a starting screen of user device 110, may perform a particular swipe or other gesture on the touchscreen of user device 110, may speak an audio command, may shake user device 110 in a particular pattern, and/or may perform another action to activate the privacy mode. As another example, the privacy mode may be activated based on a detected privacy mode trigger.

A privacy mode trigger may also be based on a privacy tag associated with a data item. For example, an email may include a password for an account associated with the user and the password may be tagged with a privacy tag. If the user opens the email with the password, display mode controller 701 may detect the privacy tag and may activate the privacy mode.

A privacy mode trigger may also be based on a data type associated with the data item. For example, data items associated with a financial data type tag may trigger the privacy mode. A privacy mode trigger may be based on a data source associated with the data item. For example, data items received from a particular user, a particular organization, a particular Internet Protocol address, and/or another type of data source may trigger the privacy mode.

A privacy mode trigger may also be based on the location of user device 110. As an example, the user may designate a home location and locations away from the home location to trigger the privacy mode. As another example, if user device 110 is detected to be moving within a particular range of speeds, display mode controller 701 may determine that the user is using public transportation and may trigger the privacy mode in response.

A privacy mode trigger may also be based on a time of day or a day of week. For example, privacy mode may be turned off at night and/or on weekends and may be turned on during the day. A privacy mode trigger may be based on an access point device. For example, when connected to a WiFi access point and/or wireless base station at the user's home and/or work location, display mode controller 701 may select the normal viewing mode and when connected to public WiFi access point and/or a different wireless base station, display mode controller 701 may activate the privacy mode.

A privacy mode trigger may also be based on detection of color filters device 210. For example, when the user picks up user device 110, the motion may activate a front camera of user device 110 and the front camera may detect trigger pattern 230 based on the user wearing color filters device 210. In response, display mode controller 701 may activate the privacy mode.

An area of display where privacy mode is to be applied may be determined (block 930) and privacy mode may be applied to the determined area of display (block 940). As an example, display mode controller 701 may apply the privacy mode only to a particular data item being displayed, such as a password, person identification number (PIN), credit card information, text boxes or other input fields where the user enters personal information, and/or other types of private information. As another example, display mode controller 701 may apply the privacy mode to a particular application, such as a web browser or a media player application and may apply the privacy mode to a window or frame of display 120 on which the web browser or media player application is displaying information. As yet another example, the user may select a particular area of display device by tracing out a shape or otherwise selecting a particular area of display 120. For example, the user may wish to discuss something displayed on the screen with another user while obscuring some information from the user (e.g., showing an email to another user while not revealing the sender of the email).

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while series of blocks have been described with respect to FIGS. 8 and 9, the order of the blocks may be modified in other implementations. Further, non-dependent blocks may be performed in parallel.

As another example, while implementations described herein have been described with respect to a mobile communication device, other implementations may include different types of user devices, such as a television, a gaming console, a screen of an automated teller machine, etc. For example, parents may activate privacy mode on a television and may watch a movie not appropriate for young children by wearing color filters device 210, while the young children are playing in the same room.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code—it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

It should be emphasized that the terms “comprises”/“comprising” when used in this specification are taken to specify the presence of stated features, integers, steps or components but does not preclude the presence or addition of one or more other features, integers, steps, components or groups thereof.

The term “logic,” as used herein, may refer to a combination of one or more processors configured to execute instructions stored in one or more memory devices, may refer to hardwired circuitry, and/or may refer to a combination thereof. Furthermore, a logic may be included in a single device or may be distributed across multiple, and possibly remote, devices.

For the purposes of describing and defining the present invention, it is additionally noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

No element, act, or instruction used in the present application should be construed as critical or essential to the embodiments unless explicitly described as such. Also, as used herein, the article “a” is intended to include one or more items. Further, the phrase “based on” is intended to mean “based, at least in part, on” unless explicitly stated otherwise.

1. A device comprising:
a color display that includes a plurality of pixels, wherein each of the plurality of pixels comprise:
a first set of subpixels configured to emit a first set of colors; and
a second set of subpixels configured to emit a second set of colors, wherein the second set of colors is offset from the first set of colors by a wavelength range;
a processor that executes logic to cause the device to:
obtain an image and display the image with the first set of subpixels;
detect activation of a privacy mode and, in response to detecting the activation of the privacy mode:
generate an inverse image of the obtained image; and
display the generated inverse image with the second set of subpixels, light emitted by the first set of subpixels and light emitted by the second set of subpixels combining to form a grey image; and
a filter assembly comprising a set of color filters separated from the color display, the set of color filters transparent to the first set of colors and block the second set of colors, the filter assembly further comprising a trigger pattern recognizable to the device when positioned in a triggering position relative to the display, recognition of the trigger pattern being the detection that activates the privacy mode.

2. (canceled)

3. The device of claim 1, wherein the first set of subpixels includes a red subpixel, a green subpixel, and a blue subpixel, and wherein the second set of subpixels includes an offset red subpixel that is offset from the red subpixel by a first wavelength range, an offset green subpixel that is offset from the green subpixel by a second wavelength range, and an offset blue subpixel that is offset from the blue subpixel by a third wavelength range.

4. The device of claim 3, wherein the first set of subpixels includes a first set of color filters and wherein the second set of subpixels includes a second set of color filters.

5. The device of claim 3, wherein a light source for the color display includes at least one of an inorganic light emitting diode (LED) or an organic light emitting diode (OLED).

6. The device of claim 1, wherein the first set of subpixels includes a red light emitting diode (LED), a green LED, and a blue LED, and wherein the second set of subpixels includes an offset red LED that emits light offset from the red LED by a first wavelength range, an offset green LED that emits light offset from the green LED by a second wavelength range, and an offset blue LED that emits light offset from the blue LED by a third wavelength range.

7. The device of claim 6, wherein the color display is a field sequential display.

8. The device of claim 7, wherein execution of the logic further causes the device to:
display the obtained image using the first set of subpixels during a first cycle of the field sequential display; and
display the generated inverse image using the second set of subpixels during a second cycle of the field sequential display, wherein the first cycle and the second cycle alternate in time.

9. (canceled)

10. (canceled)

11. The device of claim 1, wherein the privacy mode is applied to a determined area of the color display that is less than an entire area of the color display.

12. A method, performed by a computing device having a color display that includes a plurality of pixels, each of the plurality of pixels including a first set of subpixels configured to emit a first set of colors and a second set of subpixels configured to emit a second set of colors that are offset from the first set of colors by a wavelength range, comprising:
obtaining, by the computing device, an image;
detecting, by the computing device, activation of a privacy mode, the activation of the privacy mode comprising detecting placement of a filter assembly having a set of color filters separate from the color display and a trigger pattern recognizable to the computing device in a triggering position relative to the display, the set of color filters transparent to the first set of colors and block the second set of colors;
generating, by the computing device, an inverse image of the obtained image;
displaying, by the computing device and on the color display, the obtained image using a first set of subpixels; and
displaying, by the computing device and on the color display, the generated inverse image using a second set of subpixels, in response to detecting the activation of the privacy mode.

13. The method of claim 12, wherein the first set of subpixels includes a red subpixel, a green subpixel, and a blue subpixel, and wherein the second set of subpixels includes an offset red subpixel that is offset from the red subpixel by a first wavelength range, an offset green subpixel that is offset from the green subpixel by a second wavelength range, and an offset blue subpixel that is offset from the blue subpixel by a third wavelength range.

14. The method of claim 13, wherein the first set of subpixels includes a first set of color filters, wherein the second set of subpixels includes a second set of color filters, and wherein a light source for the color display includes at least one of an inorganic light emitting diode (LED) or an organic light emitting diode (OLED).

15. The method of claim 12, wherein the first set of subpixels includes a red light emitting diode (LED), a green LED, and a blue LED, and wherein the second set of subpixels includes an offset red LED that emits light offset from the red LED by a first wavelength range, an offset green LED that emits light offset from the green LED by a second wavelength range, and an offset blue LED that emits light offset from the blue LED by a third wavelength range.

16. The method of claim 15, wherein the color display is a field sequential display, the method further comprising:
displaying the obtained image using the first set of subpixels during a first cycle of the field sequential display; and
displaying the generated inverse image using the second set of subpixels during a second cycle of the field sequential display, wherein the first cycle and the second cycle alternate in time.

17. (canceled)

18. The method of claim 12, wherein the privacy mode is applied to a determined area of the color display that is less than an entire area of the color display.

19-20. (canceled)
